(19) United States
(12) Patent Application Publication
(10) Pub. No.: US 2004/0221940 A1
(43) Pub. Date: Nov. 11, 2004

(54) Sealing device for protection against harmful biological and chemical agents and sealing method

(76) Inventor: Barbara S. Harte, Fountain Hills, AZ (US)

Correspondence Address: WEISS & MOY PC, 4204 NORTH BROWN AVENUE, SCOTTSDALE, AZ, 85251, US

(21) Appl. No.: 10/430,122

(22) Filed: May 5, 2003

(51) Int. Cl. B32B 33/00; B32B 31/00

(52) U.S. Cl. 156/71; 156/247; 156/249; 428/40.1

(57) ABSTRACT

A sealing device for protecting individuals within a building or home against harmful biological and chemical agents outside the building or home comprising a plastic sheet, pre-sized to fit, for example, over a standard-dimension window and having an adhesive strip, the adhesive strip being attached along an outer peripheral edge portion of the plastic sheet for securing the plastic sheet over the window and a method of separating at least one sealing device from a supply roll of identical sealing devices, peeling off a removable backing strip from the adhesive strip in order to expose a tacky surface of the adhesive strip, and systematically adhering the tacky surface of the adhesive strip along a window opening so as to secure the sealing device over the window or window area.

### FIELD OF THE INVENTION

This invention relates generally to building or home safety devices and, more specifically, to a sealing device and method for protecting individuals within a building or home against harmful biological and chemical agents outside the building or home.

### BACKGROUND OF THE INVENTION

In the wake of the Sep. 11, 2001 terrorist attacks on the World Trade Center and the United States Pentagon, many individuals fear further terrorist aggression. It is widely believed that future assaults may possibly involve the use of biological and chemical weapons.

Chemical weapons use deadly manufactured chemicals, similar to and obviously more powerful than those used in insecticides. Chemical weapons also use deadly gasses such as sarin gas (a nerve gas), VX gas (similar to sarin), and mustard gas. Biological weapons use a bacteria strain such as Anthrax. Biological weapons also use viruses, possibly the Ebola virus or Smallpox. While both chemical and biological agents may be spread through public water supplies and through municipal food supplies, what is most feared is the deadly agents' ability to be spread through the air.

Almost all buildings and homes have windows. A common fear is that a window will shatter, thereby allowing biological or chemical agents in the outer atmosphere to enter the building or home. Even if a window is not shattered, the toxic air may still be able to enter the building or home through cracks or holes in or near the window.

Many individuals have attempted to seal the windows or window areas by cutting large plastic bags, stretching them across the windows or window areas, and securing or attaching the plastic with duct tape. This may prove to be problematic because the individual must guess as to whether or not the plastic will be large enough to sufficiently cover a given window or window area. Furthermore, cutting the plastic bags, stretching the plastic over the window or window area, simultaneously measuring the duct tape, cutting the duct tape, and taping the plastic to the area of the window opening is an entirely awkward procedure and would require more than one individual to complete. These materials and this tedious method would prove to be inadequate in an emergency situation.

Therefore a need existed for a sealing device for protecting individuals within a building or home against harmful biological and chemical agents outside the building or home comprising a plastic sheet, sized to fit over a standard-dimension window or window area and having an adhesive strip, the adhesive strip being fixed along an outer periphery of the plastic sheet for securing the plastic sheet over the window or window area.

### SUMMARY OF THE INVENTION

An object of the present invention is to provide an improved sealing device for protecting individuals within a building or home against harmful biological and chemical agents outside the building or home and sealing method.

Another object of the present invention is to provide a sealing device for protecting individuals within a building or home against harmful biological and chemical agents outside the building or home comprising a plastic sheet that is pre-sized to fit over a standard-dimension window or window area and has an adhesive strip pre-fixed along an outer periphery and on an outer surface of the plastic sheet for securing or attaching the plastic sheet over the window or window area.

Another object of the present invention is to provide a sealing device for protecting individuals within a building or home against harmful biological and chemical agents outside the building or home comprising a plastic sheet that is pre-sized to fit over a standard-dimension window or window area and has an adhesive strip pre-fixed along an outer periphery and on an inner surface of the plastic sheet for securing or attaching the plastic sheet over the window or window area.

Yet another object of the present invention is to provide an improved sealing method which comprises separating at least one sealing device from a supply roll of identical sealing devices, peeling off a removable backing strip from the adhesive strip in order to expose a tacky surface of the adhesive strip, and systematically adhering the tacky surface of the adhesive strip along a window area opening so as to secure the sealing device over the window or window area.

### BRIEF DESCRIPTION OF THE PREFERRED EMBODIMENTS

In accordance with one embodiment of the present invention, a sealing device for protecting individuals within a building or home against harmful biological and chemical agents outside the building or home comprising a plastic sheet, pre-sized to fit over a standard-dimension window or window area and having perforated edges along which the plastic sheet is torn and separated from a supply roll of identical plastic sheets. The plastic sheet also has an adhesive strip pre-fixed or pre-attached along an outer peripheral edge portion of the plastic sheet for securing the plastic sheet over a window or window area. The adhesive strip is attached on an inner exterior surface of the plastic sheet and is completely contained within the outer peripheral edge portion of the plastic sheet. This embodiment may be used with a window either having a window sash or being positioned within a window frame.

In accordance with another embodiment of the present invention, a sealing device for protecting individuals within a building or home against harmful biological and chemical agents outside the building or home comprising a plastic sheet, pre-sized to fit over a standard-dimension window or window area and having perforated edges along which the plastic sheet is torn and separated from a supply roll of identical plastic sheets. The plastic sheet also has an adhesive strip pre-fixed or pre-attached along an outer peripheral edge portion of the plastic sheet for securing the plastic sheet over a window or window area. The adhesive strip is attached on an inner interior surface of the plastic sheet and extends beyond the outer peripheral edge portion of the plastic sheet. This embodiment may be used with a window either having a window sash or being positioned within a window frame.

In accordance with yet another embodiment of the present invention, a method for sealing a window of a building or home so as to prevent harmful biological and chemical agents from entering comprising the steps of providing a supply roll of a sealing device for protecting individuals within a building or home against harmful biological and chemical agents outside the building or home. The sealing device comprises a plastic sheet and an adhesive strip fixed along an outer peripheral edge portion of the plastic sheet. The individual will separate at least one sealing device from the supply roll, the at least one sealing device being pre-sized to fit over a standard-dimension window or window area and having perforated edges for facilitating separation. Then the individual will peel off a removable backing strip from the adhesive strip in order to expose a tacky surface of the adhesive strip. Finally, the individual will systematically adhere the tacky surface of the adhesive strip along a window opening so as to secure the sealing device over the window or window area.

The foregoing and other objects, features, and advantages of the invention will be apparent from the following, more detailed description of the preferred embodiments of the invention, as illustrated in the accompanying drawings.

### BRIEF DESCRIPTION OF THE DRAWINGS

FIG. 1 is a perspective view of a first embodiment of the protective sealing device of the present invention, shown with a window positioned within a window frame and shown with a bottom corner of the plastic sheet of the protective sealing device (spaced away from the window) pulled back to reveal an adhesive strip attached along and completely contained within the outer periphery portion (shown in phantom lines) of the plastic sheet on an inside exterior surface of the plastic sheet.

FIG. 2 is a perspective view of a portion of the inside exterior surface of the plastic sheet shown in FIG. 1, shown with a removable backing strip partially peeled off to expose a tacky surface of the adhesive strip.

FIG. 3 is a front elevational view of a portion of the protective sealing device of FIG. 1, shown fixed to a window having a window sash and shown with a top corner of the plastic sheet pulled back to reveal the adhesive strip.

FIG. 4 is a perspective view of a second embodiment of a portion of the protective sealing device of the present invention showing an adhesive strip attached to an inner exterior surface of the plastic sheet wherein the adhesive strip is shown extending beyond the outer peripheral edge of the plastic sheet.

FIG. 5 is a perspective view of a supply roll of plastic sheets of the protective sealing device of the present invention, shown with a corner of one plastic sheet pulled back and separated along one of its perforated edges (shown with dashed lines).

### DETAILED DESCRIPTION OF THE PREFERRED EMBODIMENTS

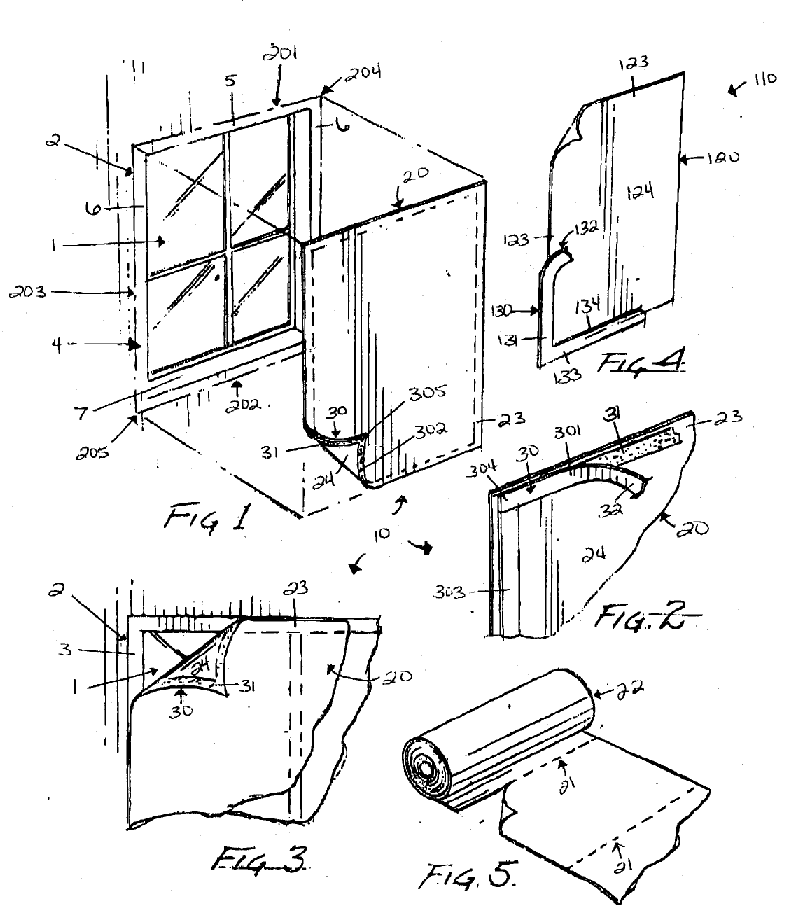

FIGS. 1-3 disclose a sealing device 10 for protecting individuals within a building or home against harmful biological and chemical agents outside the building or home comprising in combination, a plastic sheet 20 for sealing a window or window area 1 of a building or home and an adhesive strip 30 for securing or attaching the plastic sheet 20 over the window or window area 1. The plastic sheet 20 is pre-sized to fit over a standard-dimension window or window area 1 and has perforated edges (see FIG. 5) at each end of the plastic sheet 20 along which the plastic sheet 20 is torn and separated from a supply roll (see FIG. 5) of identical plastic sheets 20.

The adhesive strip 30 is fixed along an outer peripheral edge portion 23 and on an inner exterior surface 24 of the plastic sheet 20. The adhesive strip 30 is also completely contained within the outer peripheral edge portion 23 of the plastic sheet 20. The adhesive strip 30 further comprises a tacky surface 31 for adhering along an outer edge portion of the window opening 2 and a removable backing strip 32 (see FIG. 2) that is fixed to the tacky surface 31 of the adhesive strip 30 so as to protect the tacky surface 31 prior to use of the sealing device 10.

FIG. 1 shows the sealing device 10 attached to a window opening 2 containing a window 1 that is positioned within a window frame 4 and the window frame 4 is flush with the window opening 2. The window frame 4 comprises a head jamb 5, two side jambs 6, and a sill 7.

FIG. 3 shows the sealing device 10 attached to the window opening 2 wherein the window 1 has a sash 3 and the sash 3 is flush with the window opening 2.

FIG. 4 shows another form of a sealing device 110 for protecting individuals within a building or home against harmful biological and chemical agents outside the building or home comprising in combination, a plastic sheet 120 for sealing a window or window area 1 of a building or home and an adhesive strip 130 for securing the plastic sheet 120 over the window (not shown). The plastic sheet 120 is pre-sized to fit over a standard-dimension window or can be pre-sized to fit over any dimensioned window area and has perforated edges (see FIG. 5) along which the plastic sheet 120 is torn and separated from a supply roll (see FIG. 5) of identical plastic sheets 120.

The adhesive strip 130 is fixed along an outer peripheral edge portion 123 and on an inner interior surface 124 of the plastic sheet 120, however, the adhesive strip 130 extends beyond and overlaps the outer peripheral edge portion 123 of the plastic sheet 120. The adhesive strip 130 further comprises, a first surface 131 that is non-tacky and a second surface 132. The second surface 132 has a lateral edge 133 that is tacky so as to adhere along a window opening 2. The second surface 132 also has a medial edge 134 that is attached along the outer peripheral edge portion 123 of the plastic sheet 120. The adhesive strip 130 also has a removable backing strip (not shown), the backing strip being fixed to the lateral edge 133 of the second surface 132 of the adhesive strip 130 so as to protect the tackiness of the lateral edge 133 prior to use of the sealing device 110.

FIG. 5 discloses a plastic sheet 20 having perforated edges 21 along which the plastic sheet 20 is torn and separated from a supply roll 22 of identical plastic sheets 20.

### Statement of Operation

FIGS. 1-3 show a method for providing a supply roll (see FIG. 5) of a sealing device 10 for protecting individuals within a building or home against harmful biological and chemical agents outside the building or home wherein the sealing device 10 comprises a plastic sheet 20 and an adhesive strip 30 fixed along an outer peripheral edge portion 23 of the plastic sheet 20. In order to seal a window or window area 1, an individual must separate at least one sealing device 10 from the supply roll (see FIG. 5). The at least one sealing device 10 is pre-sized to fit over a standard-dimension window or window area 1 and has perforated edges (see FIG. 5) for facilitating separation. The individual must then peel off a removable backing strip (see FIG. 2) from the adhesive strip 30 in order to expose a tacky surface 31 of the adhesive strip 30. Finally, the individual will systematically adhere the tacky surface 31 of the adhesive strip 30 along a window opening 2 so as to secure the sealing device 10 over the window or window area 1.

As shown in FIG. 1, the window opening 2 of the window or window area 1 comprises a top edge 201, a bottom edge 202, and two side edges 203, creating two top connecting corners 204 and two bottom connecting corners 205.

As shown in FIG. 2, the adhesive strip 30 has a top portion 301, a bottom portion 302 (see FIG. 1), and two side portions 303, creating two top connecting corners 304 and two bottom connecting corners 305 (see FIG. 1).

To systematically adhere the tacky surface 31 of the adhesive strip 30 along a window opening 2 the individual will secure one of the top connecting corners 304 of the adhesive strip 30 to the corresponding top connecting corner 204 of the window opening 2. Next, the individual will secure the other of the top connecting corners 304 of the adhesive strip 30 to the corresponding top connecting corner 204 of the window opening 2. The individual will then smooth and secure the top portion 301 of the adhesive strip 30 along the corresponding top edge 201 of the window opening 2.

Subsequently, the individual will secure the bottom connecting corners 305 of the adhesive strip 30, one at a time, to the corresponding bottom connecting corners 205 of the window opening 2 and will smooth and secure the bottom portion 302 of the adhesive strip 30 along the corresponding bottom edge 202 of the window opening 2.

Finally, the individual will smooth and secure the side portions 302 of the adhesive strip 30 along the corresponding side edges 202 of the window opening 2.

While the invention has been particularly shown and described with reference to preferred embodiments thereof, it will be understood by those skilled in the art that the foregoing and other changes in form and details may be made therein without departing from the spirit and scope of the invention. For example, the at least one sealing device 10 may be pre-sized to fit over a standard-dimension door, doorway, vent, or other opening into a room in order to protect an individual against harmful biological and chemical agents without departing from the spirit and scope of the invention. In addition, it should be clearly understood that it is within the spirit and scope of this invention that the at least one sealing device 10 may also be adhered along a window opening 2 in order to keep out rain, wind, or other unwanted elements.

1. A sealing device for protecting individuals within a building or home against harmful biological and chemical agents outside the building or home comprising in combination:
a plastic sheet, the plastic sheet having a thickness of at least 2.5 mm and being substantially resistant to harmful biological and chemical agents, being pre-sized to fit over an interior surface of at least one of a standard-dimension window and window area of at least one of a building and home and having perforated edges along which the plastic sheet is torn and separated from a supply roll of identical plastic sheets; and
an adhesive strip for securing the plastic sheet over the interior surface of said at least one window and window area, the adhesive strip being one of re-fixed and pre-attached along an outer peripheral edge portion of the plastic sheet and on an inner exterior surface of the plastic sheet.

2. The sealing device of claim 1 wherein the adhesive strip is completely contained within the outer peripheral edge portion of the plastic sheet.

3. The sealing device of claim 1 wherein the adhesive strip further comprises:
a tacky surface for adhering along a window opening; and
a removable backing strip, the backing strip being attached to the tacky surface of the adhesive strip so as to protect the tacky surface prior to use of the sealing device.

4. The sealing device of claim 1 wherein the window or window area has a sash, the sash being flush with the window opening of a building or home.

5. The sealing device of claim 1 wherein the window is positioned within a window frame, the window frame having a head jamb, two side jambs, and a sill and being flush with the window opening of a building or home.

6. A sealing device for protecting individuals within a building or home against harmful biological and chemical agents outside the building or home comprising in combination:
a plastic sheet, the plastic sheet having a thickness of at least 2.5 mm and being substantially resistant to harmful biological and chemical agents being pre-sized to fit over an interior surface of at least one of a standard-dimension window and window area of at least one of a building and home and having perforated edges along which the plastic sheet is torn and separated from a supply roll of identical plastic sheets; and
an adhesive strip for securing the plastic sheet over the interior surface of said at least one window and window area, the adhesive strip being one of pre-fixed and pre-attached along an outer peripheral edge portion of the plastic sheet and on an inner interior surface of the plastic sheet.

7. The sealing device of claim 6 wherein the adhesive strip extends beyond the outer peripheral edge portion of the plastic sheet.

8. The sealing device of claim 6 wherein the adhesive strip further comprises:
a first surface, the entire first surface being non-tacky;
a second surface having;
a lateral edge, the lateral edge being tacky so as to adhere along a window opening;
a medial edge, the medial edge being attached along the outer peripheral edge portion of the plastic sheet; and
a removable backing strip, the backing strip being attached to the lateral edge of the second surface of the adhesive strip so as to protect the tackiness of the lateral edge prior to use of the sealing device.

9. The sealing device of claim 6 wherein the window has a sash, the sash being flush with the window opening of a building or home.

10. The sealing device of claim 6 wherein the window is positioned within a window frame, the window frame having a head jamb, two side jambs, and a sill and being flush with the window opening of a building or home.

11. A method for sealing a standard-dimension window of a building or home so as to prevent harmful biological and chemical agents from entering comprising the steps of:
providing a supply roll of a sealing device for protecting individuals within at least one of a building and home against harmful biological and chemical agents outside said at least one of building and home, the sealing device comprising a plastic sheet being substantially resistant to harmful biological and chemical agents and being pre-sized to fit over an interior surface of at least one of a standard-dimension window and window area of one of a building and a home and an adhesive strip fixed along an outer peripheral edge portion of the plastic sheet;
separating at least one sealing device from the supply roll, the at least one sealing device being pre-sized to fit over at least one of a standard-dimension window and window area and having perforated edges for facilitating separation;
peeling off a removable backing strip from the adhesive strip in order to expose a tacky surface of the adhesive strip;
systematically adhering the tacky surface of the adhesive strip along a window opening so as to secure the sealing device over the interior surface of at least one of the window and window area.

12. The method of claim 11 wherein the window opening of the window comprises a Lop edge, a bottom edge, and two side edges, creating two to connecting corners and two bottom connecting corners.

13. The method of claim 11 wherein the adhesive strip has a top portion, a bottom portion, and two side portions, creating two top connecting corners and two bottom connecting corners.

14. The method of claim 11 wherein the step of systematically adhering the tacky surface of the adhesive strip along a window opening further comprises the steps of:
securing one of the top connecting corners of the adhesive strip to the corresponding top connecting corner of the window opening;
securing the other of the top connecting corners of the adhesive strip to the corresponding top connecting corner of the window opening;
smoothing and securing the top portion of the adhesive strip along the corresponding top edge of the window opening;
securing one of the bottom connecting corners of the adhesive strip to the corresponding bottom connecting corner of the window opening;
securing the other of the bottom connecting corners of the adhesive strip to the corresponding bottom connecting corner of the window opening;
smoothing and securing the bottom portion of the adhesive strip along the corresponding bottom edge of the window opening;
smoothing and securing one of the side portions of the adhesive strip along the corresponding side edge of the window opening; and
smoothing and securing the other of the side portions of the adhesive strip along the corresponding side edge of the window opening.
